(19) United States
(12) Patent Application Publication
(10) Pub. No.: US 2025/0329078 A1
(43) Pub. Date: Oct. 23, 2025

(54) METHOD FOR GENERATING A TWO-DIMENSIONAL RAPPORT

(71) Applicant: WAIXO FASHION & DIGITAL SOLUTIONS, S.L., GORDEXOLA (ES)

(72) Inventor: Adolfo Prudencio MUGUERZA TINOCO, BARRIKA (ES)

(21) Appl. No.: 19/259,485

(22) Filed: Jul. 3, 2025

Related U.S. Application Data
(63) Continuation of application No. PCT/ES2023/070021, filed on Jan. 16, 2023.

(51) Int. Cl. G06T 11/40; G06T 7/11; G06T 11/00

(52) U.S. Cl. CPC G06T 11/40; G06T 7/11; G06T 11/001

(57) ABSTRACT

A computer-implemented method for generating a two-dimensional rapport starting from an image. The method includes a division step in which the image is divided into at least three portions by at least a first cutting line and a second cutting line that intersect one another. Each of the at least three portions including a part of the image and an inner contour generated by the cutting lines. The method also includes a displacement step in which the rapport is generated by displacing each of the at least three portions linearly to a diametrically opposite position, such that the rapport includes a closed contour formed by at least part of the inner contours of the at least three portions.

### CROSS-REFERENCE TO RELATED APPLICATIONS

This application relates to and claims the benefit of International Application No. PCT/ES2023/070021, filed Jan. 16, 2023, which is incorporated by reference herein in its entirety.

### TECHNICAL FIELD

The present invention relates to methods for generating a two-dimensional rapport.

### BACKGROUND

A repetition design, a modular illustration, or a pattern is a design based on the vertical (top to bottom) and horizontal (right to left) repetition of a module. There are multiple possibilities in which a module can be arranged to give rise to a modular illustration. For example, a square-shaped module can give rise to a grid when repeated vertically and horizontally, to a modular illustration with a brick design when each sequence of modules in the horizontal direction is shifted horizontally with respect to the sequence above it, or in a triplet when each sequence of modules in the vertical direction is shifted vertically with respect to the sequence to its left, among others. In addition, the modules do not necessarily have to be square-shaped, but can adopt other shapes, such as triangle, hexagon, flake, etc. Each module is also known as a repeating pattern, modular pattern or rapport. Repeating patterns can be used to be printed on any physical support, for example, fabric, paper, vinyl, wallpaper, painted paper, mugs, trays, posters, etc., although they are also used in editorial illustration or as background in web applications, among others.

One of the considerations to take into account when generating a pattern is that when repeating the rapport horizontally and vertically, the continuity of the image, drawing, design, or illustration of said rapport must be guaranteed at the joints between the different rapports that make up the pattern. For this, it is necessary that the image of the rapport has continuity in the following rapport in the sequence of rapports that compose the pattern, both vertically and horizontally.

The generation of patterns from a rapport is now known. However, there are two possibilities to make this possible. In the first one, the outline of the rapport is empty, thus guaranteeing the continuity of the image by repeating vertically and horizontally, since it would be empty. The second possibility is that the image of the rapport is designed in such a way that the part of the image in the outline of each rapport has continuity with the image of the next rapport by arranging the two into a repetition design, a modular illustration, or a pattern.

### SUMMARY

The object of the invention is to provide a computer-implemented method for generating a two-dimensional rapport starting from an image, as defined in the claims.

The computer-implemented method of the invention comprises a division step in which the image is divided into at least three portions by means of at least a first cutting line and a second cutting line, which intersect one another. Each portion comprises a part of the image and an inner contour generated by the cutting lines. The method comprises furthermore a displacement step in which the rapport is generated by displacing each portion linearly to a diametrically opposite position, such that the rapport comprises a closed contour formed by at least part of the inner contours of the portions.

The method of the invention allows obtaining a two-dimensional rapport starting from any two-dimensional image, wherein it is not necessary for the contour of said starting image to be empty, or for the starting image to be designed such that the part of the image in the contour has continuity with the contiguous image in the case of said starting image being repeated vertically and horizontally.

These and other advantages and features will become apparent in view of the figures and detailed description.

### BRIEF DESCRIPTION OF THE DRAWINGS

FIG. 1 shows a blank image 1 used in a first embodiment of the method of the invention.

FIG. 2 shows the rapport 2 obtained from the image 1 of FIG. 1 by means of the first embodiment of the method of the invention.

FIG. 3 shows an image 1 used in a second embodiment of the method of the invention.

FIG. 4 shows the rapport 2 obtained from the image 1 of FIG. 3 after the displacement step 102 of the second embodiment of the method.

FIG. 5 shows the rapport 2 of FIG. 4 after the filling step 106 of the second embodiment of the method.

FIG. 6 shows a pattern obtained from the rapport 2 of FIG. 5.

FIG. 7b shows an image 1 used in a third embodiment of the method of the invention, and FIG. 7A shows the image 1 of FIG. 7b, blank in this case.

FIGS. 8A and 8B show the rapport 2 obtained from the image 1 of FIGS. 7A and 7b after the displacement step 102 of the third embodiment of the method.

FIG. 9 shows the rapport 2 of FIG. 8B after the filling step 106 of the third embodiment of the method.

FIG. 10b shows an image 1 used in fourth and fifth embodiments of the method of the invention, and FIG. 10a shows the image 1 of FIG. 10B, blank in this case.

FIG. 11 shows the rapport 2 obtained from the image 1 of FIG. 10a after the displacement step 102 of the fourth embodiment of the method.

FIGS. 12A and 12B show the rapport 2 obtained from the image 1 of FIGS. 10a and 10B before the filling step 106 of the fourth embodiment of the method.

FIG. 13 shows the rapport 2 of FIG. 12B after the filling step 106 of the fourth embodiment of the method.

FIG. 14 shows the rapport 2 obtained from the image 1 of FIG. 10a after the displacement step 102 of the fifth embodiment of the method.

FIGS. 15A and 15B show the rapport 2 obtained from the image 1 of FIGS. 10a and 10B before the filling step 106 of the fifth embodiment of the method.

FIG. 16 shows the rapport 2 of FIG. 15B after the filling step 106 of the fifth embodiment of the method.

FIG. 17 shows a blank image 1 used in a sixth embodiment of the method of the invention.

FIG. 18 shows the rapport 2 obtained from the image 1 of FIG. 17 by means of the sixth embodiment of the method of the invention.

FIG. 19 shows a schematic depiction of an embodiment of the computer 500 configured to implement the method of the invention.

FIG. 20 shows the flowchart of an embodiment of the method of the invention.

### DETAILED DESCRIPTION

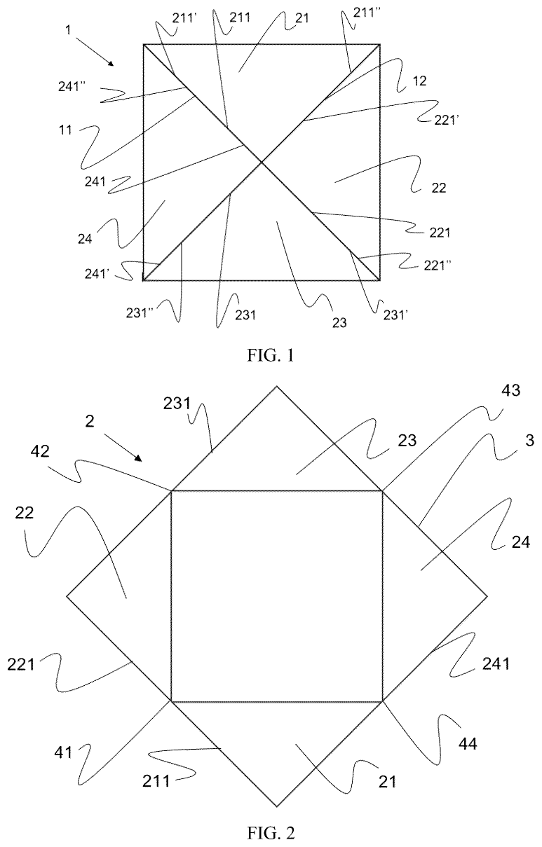

FIGS. 1 to 18 are related to a first, a second, a third, a fourth, a fifth, and a sixth embodiment of a computer-implemented method for generating a two-dimensional rapport 2 starting from an image 1, according to the invention.

The computer-implemented method of the invention comprises a division step 101 in which the image 1 is divided into at least three portions 21, 22, 23, 24 by means of at least a first cutting line 11 and a second cutting line 12 which intersect one another, each portion 21, 22, 23, 24 comprising a part of the image 1 and an inner contour 211, 221, 231, 241 generated by the cutting lines 11, 12, and a displacement step 102 in which the rapport 2 is generated by displacing each portion 21, 22, 23, 24 linearly to a diametrically opposite position, such that the rapport 2 comprises a closed contour 3 formed by at least part of the inner contours 211, 221, 231, 241 of portions 21, 22, 23, 24.

In the context of the invention, the image 1 is a drawing, a design, or an illustration based on which the rapport 2 will be generated, such that once said rapport 2 is repeated horizontally and vertically giving rise to a pattern, a new image inspired on the starting image 1 is represented in said pattern. The image 1 can be real or abstract, can represent objects or parts of objects, whether real or imaginary, or textures, among others.

In the context of the invention, the first cutting line 11 and the second cutting line 12 intersect one another at, at least one point of the image 1 located inside the contour of the image 1, and as a consequence divide said image 1 into at least three portions 21, 22, 23. To that end, the first cutting line 11 and the second cutting line 12 intersect the contour of the image 1 at two points each.

The image 1 used in the method of the invention is a two-dimensional image, therefore, said image 1 is arranged in one plane. In the context of the invention, linearly displacing portions 21, 22, 23, 24 is understood to mean translating portions 21, 22, 23, 24 over the plane in which the image 1 is arranged without the orientation of portions 21, 22, 23, 24 changing, furthermore maintaining the shape and size of said portions 21, 22, 23, 24. In other words, if a first straight line were drawn in each portion 21, 22, 23, 24 joining the two points of the contour of the image 1 defining the ends of the inner contour 211, 221, 231, 241 of said portion 21, 22, 23, 24, and if after the displacement step 102 a second straight line were drawn joining said two same points of the contour of the image 1 defining the ends of the inner contour 211, 221, 231, 241 of said same portion 21, 22, 23, 24, the first straight line and the second straight line would be two parallel straight lines.

FIG. 1 shows a blank image 1 used by way of illustration in a first embodiment of the method of the invention, wherein the image 1 has a square-shaped contour. FIG. 1 shows the four portions 21, 22, 23, 24 into which the image 1 has been divided in the division step 101 of the method by means of the first cutting line 11 and the second cutting line 12. The first cutting line 11 and the second cutting line 12 are straight lines which intersect one another, and which coincide with the diagonals of the square-shaped contour. Said first cutting line 11 and second cutting line 12 intersect at a point of the image 1 located inside the square-shaped contour.

In the context of the invention, inner contour 211, 221, 231, 241 of each portion 21, 22, 23, 24 denotes that part of the contour of each portion 21, 22, 23, 24 at which the contour of said portion 21, 22, 23, 24 coincides with at least the first cutting line 11 and/or the second cutting line 12. In the image 1 shown in FIG. 1, the inner contour 211 of portion 21 consists of a first segment 211′ wherein the contour of portion 21 coincides with the first cutting line 11, and a second segment 211″ wherein the contour of portion 21 coincides with the second cutting line 12. Likewise, the inner contour 221 of portion 22 consists of a first segment 221′ wherein the contour of portion 22 coincides with the second cutting line 12, and a second segment 221″ wherein the contour of portion 22 coincides with the first cutting line 11. The inner contour 231 of portion 23 consists of a first segment 231′ wherein the contour of portion 23 coincides with the first cutting line 11, and a second segment 231″ wherein the contour of portion 23 coincides with the second cutting line 12. In the same way, the inner contour 241 of portion 24 consists of a first segment 241′ wherein the contour of portion 24 coincides with the second cutting line 12, and a second segment 241″ wherein the contour of portion 24 coincides with the first cutting line 11.

FIG. 2 shows the arrangement of portions 21, 22, 23, 24 of the image 1 of FIG. 1 once said portions have been displaced linearly to the respective diametrically opposite position in the displacement step 102. In the image 1, portion 21 is located at the top, portion 22 to the right, portion 23 at the bottom, and portion 24 to the left. Upon being linearly displaced to the respective diametrically opposite position, each portion 21, 22, 23, 24 is displaced to the position occupied by the portion 21, 22, 23, 24 facing it. In other words, portion 21 is displaced at the bottom to the position in which portion 23 was initially arranged; portion 22 is displaced to the left to the position in which portion 24 was initially arranged; portion 23 is displaced at the top to the position in which portion 21 was initially arranged; and portion 24 is displaced to the right to the position in which portion 22 was initially arranged.

In another embodiment of the method in which the image 1 is divided into an uneven number of portions, the diametrically opposite position of each portion does not correspond with the position in which another portion of the image 1 was initially arranged. For example, in an embodiment in which the image 1 is divided into three portions 21, 22, 23, upon being linearly displaced to a diametrically opposite position, portion 21 would be displaced to a position between the positions in which portion 22 and portion 23 were initially arranged; in the same way, portion 22 would be displaced to a position between the positions in which portion 21 and portion 23 were initially arranged; and portion 23 would be displaced to a position between the positions in which portion 21 and portion 22 were initially arranged.

FIG. 2 shows the rapport 2 obtained from the image 1 of FIG. 1 after the displacement step 102 of the first embodiment of the method of the invention. The rapport 2 obtained in said first embodiment of the method comprises a closed contour 3 formed by the inner contours 211, 221, 231, 241 of portions 21, 22, 23, 24. As shown in FIG. 2, the closed contour 3 of the rapport 2 is formed by the concatenation of the inner contours 211, 221, 231, 241 of portions 21, 22, 23, 24. In said embodiment, the closed contour 3 of the obtained rapport 2 is square-shaped.

In the first embodiment of the method, in the rapport 2 obtained once portions 21, 22, 23, 24 have been displaced in the displacement step 102, each portion 21, 22, 23, 24 is joined to each adjacent portion 21, 22, 23, 24 at a single point 41, 42, 43, 44, said point 41, 42, 43, 44 being located on the closed contour 3. As shown in FIG. 2, portion 21 is joined to portion 22 at only point 41, and to portion 24 at point 44. In the same way, portion 22 is joined to portion 21 at only point 41, and to portion 23 at point 42. Portion 23 is joined to portion 22 at only point 42, and to portion 24 at point 43. Lastly, portion 24 is joined to portion 23 at only point 43, and to portion 21 at point 44.

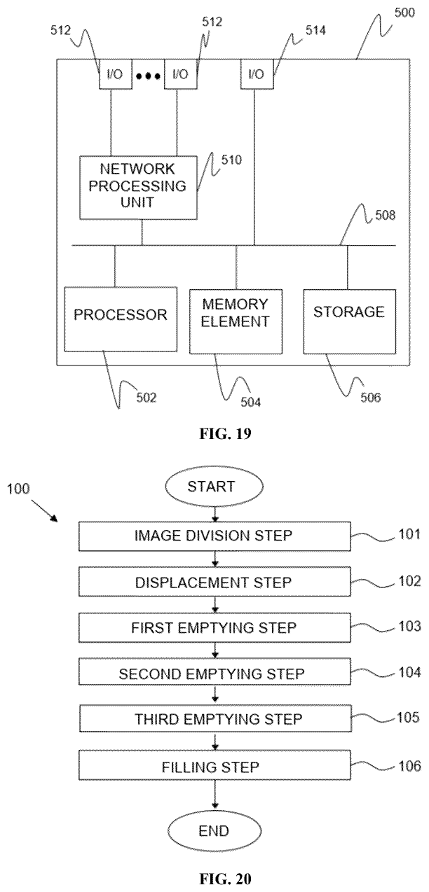

In at least one embodiment, the computer 500 used to implement the method of the invention may include one or more processors 502, one or more memory elements 504, storage 506, a bus 508, one or more network processing units 510 interconnected with one or more network input/output (I/O) interfaces 512, one or more I/O interfaces 514, and a computer program 520. FIG. 19 shows a schematic depiction of an embodiment of the computer 500 configured to implement the method of the invention.

The computer program 520 comprises a plurality of instructions which, when executed by the processor 502, cause the processor 502 to execute the steps of the method of the invention. In at least one embodiment, the processor or processors 502 are at least a hardware processor configured to execute various tasks, operations and/or functions for the computer 500 according to the software and/or the instructions configured for the computer 500, for example, in the computer program 520.

In at least one embodiment, the memory element 504 and/or storage 506 are configured to store data, information, software, and/or instructions associated with the computer 500, and/or the logic configured for the memory element 504 and/or storage 506. In an embodiment of the computer 500, the computer program 520 is stored in any combination of memory element(s) 504 and/or storage 506.

In an embodiment of the method of the invention, the image 1 is stored in a memory element 504 and/or storage 506.

In an embodiment of the method of the invention, the generated rapport 2 is stored in a memory element 504 and/or storage 506.

In at least one embodiment, the bus 508 can be configured as an interface that enables one or more elements of the computer 500 to communicate with each other so as to exchange information and/or data. The bus 508 can be implemented with any architecture designed for exchanging control, data, and/or information between processors, memory elements/storage, peripheral devices, and/or any other hardware and/or software component that may be configured for the computer 500. In at least one embodiment, the bus 508 may be implemented as a fast kernel-hosted interconnect, potentially using shared memory between processes (for example, logic), which can enable efficient communication paths between processes.

In several embodiments, the network processor unit(s) 510 may enable communication between the computer 500 and other systems, entities, etc., through the network I/O interface(s) 512 (wired and/or wireless). In several embodiments, the network processor unit(s) 510 can be configured as a combination of hardware and/or software, as one or more Ethernet drivers and/or controllers or interface cards, fiber channel (e.g., optical) driver(s) and/or controller(s), wireless receivers/transmitters/transceivers, baseband processor(s)/modem(s) and/or other similar network interface driver(s) and/or controller(s) that are known now or may be developed hereinafter so as to enable communications between the computer 500 and other systems, entities, etc., to facilitate the operations for the various embodiments of the method described herein. In several embodiments, the network I/O interface(s) 512 can be configured as one or more Ethernet ports, fiber channel ports, any other I/O port(s) and/or antennas/antenna array that are known now or may be developed in the future. Therefore, the network processor unit(s) 510 and/or the network I/O interface(s) 512 may include suitable interfaces for receiving, transmitting, and/or otherwise communicating data and/or information in a network environment.

I/O interfaces 514 allow the input and output of data and/or information with other entities which may be connected to the computer 500. For example, the I/O interfaces 514 may provide a connection to external devices such as a keyboard, numerical keypad, a touch screen, and/or any other suitable input and/or output device that is known now or may be developed in the future. In some instances, the external devices can also include (non-transitory) computer-readable storage media such as database systems, USB memories, portable optical or magnetic discs and memory cards. In still some instances, the external devices can be a mechanism for displaying data to a user, such as a computer monitor, a display screen, or the like.

In several embodiments, the computer program 520 can include instructions which, when executed, cause the processor or processors 502 to perform operations, which can include, among others, providing overall control operations of the computer, interacting with other entities, systems, etc. described herein, maintaining and/or interacting with stored data, information, parameters, etc. (for example, memory element(s), storage, data structures, databases, tables, etc.); combinations thereof; and/or the like so as to allow the execution of the operations necessary for the implementation of the method of the invention.

In some cases, the computer program 520 of the present embodiments can be available via a non-transitory computer-usable storage medium (for example, magnetic or optical media, magneto-optical media, CD-ROM, DVD, memory devices, etc.). In some cases, the non-transitory computer-readable storage media can also be removable. Other examples may include optical and magnetic discs, USB memories, and smart cards which can be inserted into and/or otherwise connected to a computer to be transferred to another computer-readable storage medium.

In one embodiment, the computer program 520 is executed in a distributed environment, i.e., part of said computer program 520 is executed in a first computer 500, and another part is executed in a second computer, both computers 500 being communicated with one another.

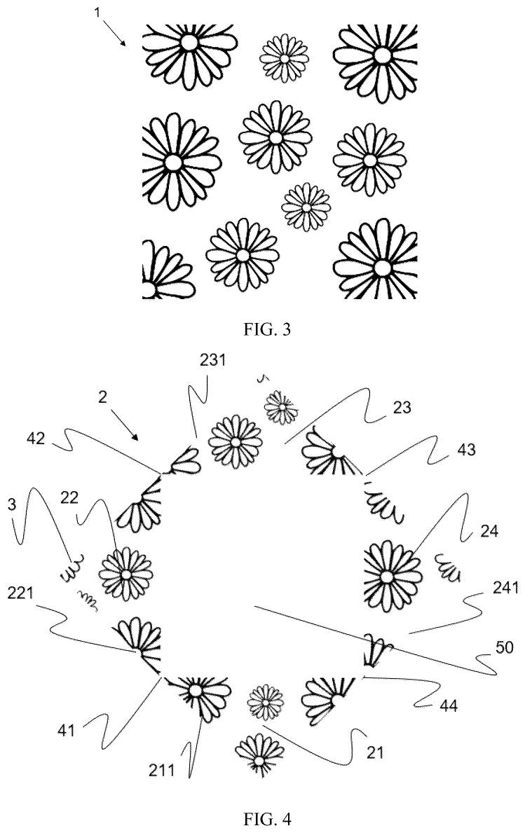

FIG. 3 shows an image 1 which, like in FIG. 1, has a square-shaped contour. The image 1 of this example consists of a plurality of flowers. It can further be seen that the image 1 is not a rapport, given that the missing part of each flower in the upper part of the image 1 is not in the lower part of said image 1. Part of other flowers which do not correspond with the missing part of each flower in the upper part of the image 1 is arranged in the lower part of the image 1. The image 1 of FIG. 3 will be used to generate a rapport 2 in a second embodiment of the method of the invention.

In the division step 101 of the second embodiment of the method, the image 1 shown in FIG. 3 is divided into four portions 21, 22, 23, 24 by means of a first cutting line 11 and a second cutting line 12, as described above for the image 1 of FIG. 1. The first cutting line 11 and the second cutting line 12 are straight lines which intersect one another, and which coincide with the diagonals of the square-shaped contour. Said first cutting line 11 and second cutting line 12 intersect at a point of the image 1 located inside the square-shaped contour. Each portion 21, 22, 23, 24 comprises a part of the image 1 and an inner contour 211, 221, 231, 241 generated by the cutting lines 11, 12.

In the displacement step 102 of the second embodiment of the method of the invention, each portion 21, 22, 23, 24 is displaced linearly to a diametrically opposite position generating a rapport 2, such that the rapport 2 comprises a closed contour 3 formed by the inner contours 211, 221, 231, 241 of portions 21, 22, 23, 24, as shown in FIG. 4. The closed contour 3 of the rapport 2 obtained in the second embodiment of the method is also square-shaped.

In the obtained rapport 2, once portions 21, 22, 23, 24 have been displaced in the displacement step 102 of the second embodiment of the method of the invention, each portion 21, 22, 23, 24 is joined to each adjacent portion 21, 22, 23, 24 at a single point 41, 42, 43, 44, said point 41, 42, 43, 44 being located on the closed contour 3 of the rapport 2, as shown in FIG. 4. Since each portion 21, 22, 23, 24 is joined to each respective adjacent portion 21, 22, 23, 24 at a single point 41, 42, 43, 44 located on the closed contour 3, it is possible for the part of the image 1 of each portion 21, 22, 23, 24 to only have one point in common with the part of the image 1 of adjacent portions 21, 22, 23, 24 in the generated rapport 2.

In the second embodiment, the method of the invention comprises a filling step 106 after the displacement step 102 in which an area 50 arranged inside the closed contour 3 in which there is not arranged any portion 21, 22, 23, 24 is filled with an image such that there is continuity between the image of said area 50 and the parts of the image 1 of portions 21, 22, 23, 24. FIG. 4 shows the rapport 2 obtained after portions 21, 22, 23, 24 are linearly displaced in the displacement step 102 of the second embodiment of the method, and having an area 50 arranged inside the closed contour 3 in which there is not arranged any portion 21, 22, 23, 24. Said area 50 is empty and shown blank in FIG. 4.

FIG. 5 shows the rapport 2 of FIG. 4 after the filling step 106, wherein the area 50 has been filled with an image with flowers, such that there is continuity between the image of the area 50 and the parts of the image 1 of portions 21, 22, 23, 24. The fact that, before the filling step 106, each portion 21, 22, 23, 24 is joined to each respective adjacent portion 21, 22, 23, 24 at a single point 41, 42, 43, 44 located on the closed contour 3 makes it possible for the image with which the area 50 has been filled to have continuity with the parts of the image 1 of portions 21, 22, 23, 24, given that the part of the image 1 of each portion 21, 22, 23, 24 only has one point in common with the part of the image 1 of adjacent portions 21, 22, 23, 24, and the image of the area 50 is generated such that said continuity exists.

The filling step 106 can be carried out manually, or by means of the use of a computer program 530. In the manual case, a graphic designer manually generates the image of the area 50 in the computer 500 used to implement the method of the invention. In the other case, the computer program 530 comprises a plurality of instructions which, when executed by the processor 502 of the computer 500, cause the processor 502 to fill the area 50 of the rapport 2 with an image generated by means of artificial intelligence, taking into account the parts of the image 1 already existing in said rapport 2. The computer program 530 is configured for the image generated in the area 50 to have the same context as that of the parts of the image 1 already existing in the rapport 2, such that once it is generated, there is continuity between the image of the area 50 and the parts of the image 1 in the rapport 2. There are multiple solutions on the market today with the characteristics and the functionality of the computer program 530, such as Dall-e 2, Stable Diffusion, or MidJourney.

In an embodiment of the method of the invention, computer program 530 is part of computer program 520, computer program 520 and computer program 530 being stored in any combination of memory element(s) 504 and/or storage 506 of the computer 500.

In one embodiment, computer program 520 and computer program 530 are executed in a distributed environment. In said embodiment, computer program 520 and computer program collaborate with one another, computer program 520 being stored in any combination of memory element(s) 504 and/or storage 506 of the computer 500, and the computer program 530 being stored in any combination of memory element(s) 504 and/or storage 506 of another computer 500. In said embodiment, the instructions of the computer program 520 are executed by a processor 502 of the computer 500, and the instructions of the computer program 530 are executed by a processor 502 of the other computer 500, both computers 500 being communicated with one another.

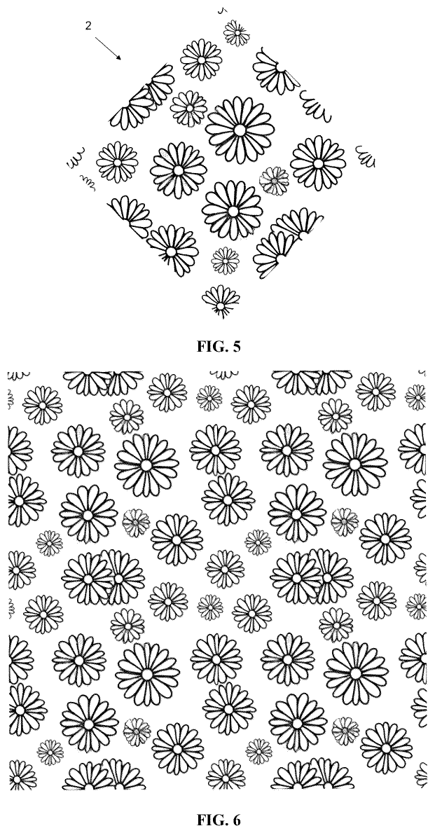

FIG. 6 shows the pattern that is generated after repeating the rapport 2 of FIG. 4 four times, twice horizontally and twice vertically.

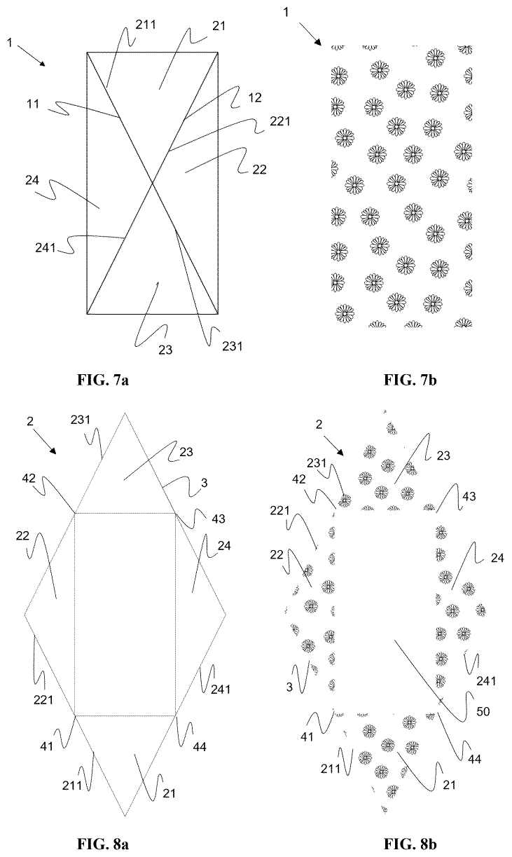

FIG. 7B shows an image 1 used in a third embodiment of the method of the invention, and FIG. 7A shows the image 1 of FIG. 7B, blank in this case. The image 1 of FIGS. 7A and 7B has a rectangular-shaped contour. It can further be observed that the image 1 of FIG. 7B is not a rapport. In the third embodiment of the method of the invention, the image 1 of FIG. 7A is used by way of illustration of said third embodiment of the method.

In the division step 101 of the third embodiment of the method of the invention, the image 1 shown in FIGS. 7A and 7B is divided into four portions 21, 22, 23, 24 by means of a first cutting line 11 and a second cutting line 12. The first cutting line 11 and the second cutting line 12 are straight lines which intersect one another, and which coincide with the diagonals of the rectangle. Said first cutting line 11 and second cutting line 12 intersect at a point of the image 1 located inside the rectangular-shaped contour. Each portion 21, 22, 23, 24 comprises a part of the image 1 and an inner contour 211, 221, 231, 241 generated by the cutting lines 11, 12.

In the displacement step 102 of the third embodiment of the invention, each portion 21, 22, 23, 24 is displaced linearly to a diametrically opposite position giving rise to a rapport 2, such that the rapport 2 comprises a closed contour 3 formed by the inner contours 211, 221, 231, 241 of portions 21, 22, 23, 24, as shown in FIGS. 8A and 8B. The closed contour 3 of the rapport 2 obtained in the third embodiment of the method is parallelogram-shaped.

In the rapport 2 obtained once portions 21, 22, 23, 24 have been displaced in the displacement step 102 of the third embodiment of the method of the invention, each portion 21, 22, 23, 24 is joined to each adjacent portion 21, 22, 23, 24 at a single point 41, 42, 43, 44, said point 41, 42, 43, 44 being located on the closed contour 3, as shown in FIGS. 8A and 8B.

In the third embodiment, the method of the invention comprises a filling step 106 after the displacement step 102 in which an area 50 arranged inside the closed contour 3 in which there is not arranged any portion 21, 22, 23, 24 is filled with an image such that there is continuity between the image of said area 50 and the parts of the image 1 of portions 21, 22, 23, 24. FIGS. 8A and 8B show the rapport 2 obtained after portions 21, 22, 23, 24 are linearly displaced in the displacement step 102 of the third embodiment of the method, and having an area 50 arranged inside the closed contour 3 in which there is not arranged any portion 21, 22, 23, 24. Said area 50 is empty and shown blank in FIGS. 8A and 8B.

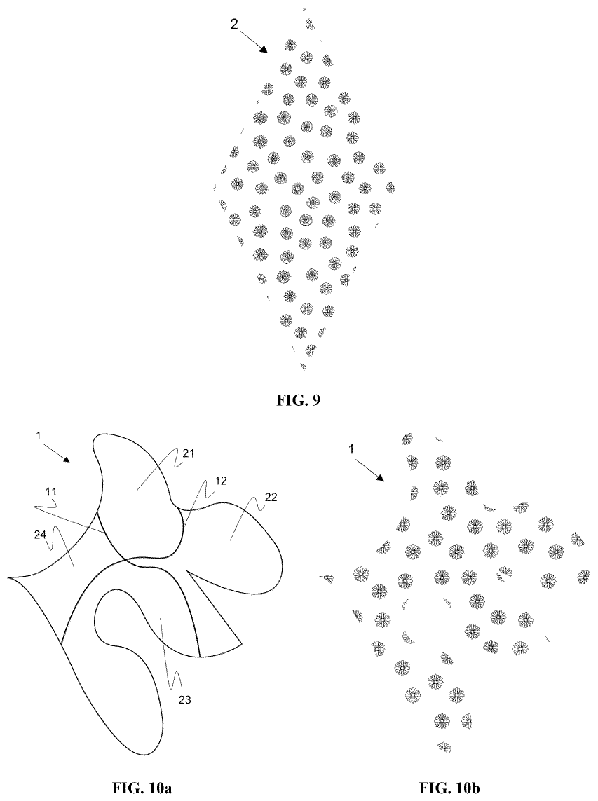

FIG. 9 shows the rapport 2 of FIG. 8B after the filling step 106, wherein the area 50 has been filled with an image with flowers, such that there is continuity between the image of the area 50 and the parts of the image 1 of portions 21, 22, 23, 24. By repeatedly arranging the rapport 2 of FIG. 9 vertically and horizontally, a pattern will be obtained.

FIG. 10b shows an image 1 used in a fourth embodiment of the method of the invention, and FIG. 10A shows the image 1 of FIG. 10b, blank in this case. The image 1 of FIGS. 10A and 10b has a curvilinear-shaped contour. In the context of the invention, the contour is understood to be curvilinear-shaped when said contour is formed by the concatenation of one or more curved lines giving rise to a closed contour. It can further be observed that the image 1 of FIG. 10b is not a rapport. In the fourth embodiment of the method of the invention, the image 1 of FIG. 10A is used by way of illustration of said fourth embodiment of the method.

In the division step 101 of the fourth embodiment of the method of the invention, the image 1 shown in FIGS. 10A and 10b is divided into four portions 21, 22, 23, 24 by means of a first cutting line 11 and a second cutting line 12. The first cutting line 11 and the second cutting line 12 are curved lines which intersect one another. Said first cutting line 11 and second cutting line 12 intersect at a point of the image 1 located inside the contour of the image 1. Each portion 21, 22, 23, 24 comprises a part of the image 1 and an inner contour 211, 221, 231, 241 generated by the cutting lines 11, 12.

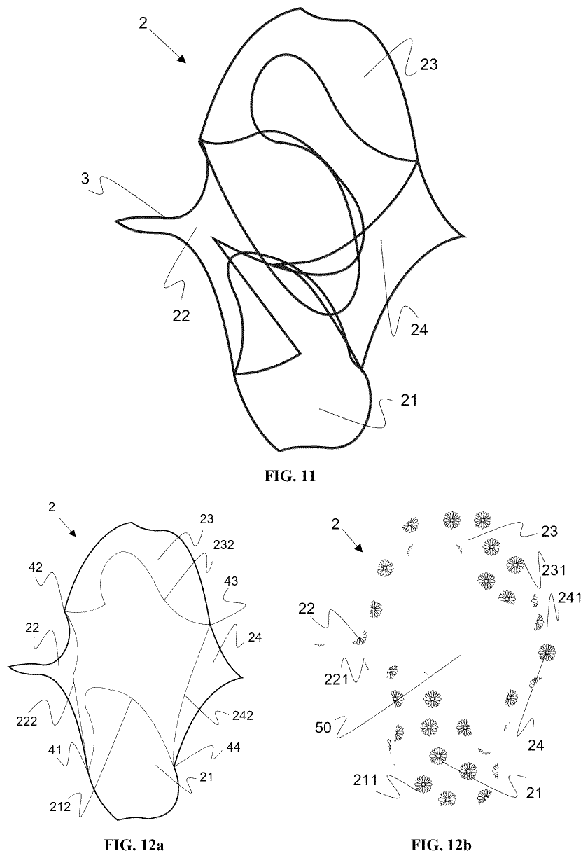

In the displacement step 102 of the fourth embodiment of the invention, each portion 21, 22, 23, 24 is displaced linearly to a diametrically opposite position giving rise to a rapport 2, such that the rapport 2 comprises a closed contour 3 formed by the inner contours 211, 221, 231, 241 of portions 21, 22, 23, 24. FIG. 11 shows the rapport 2 generated from the image 1 of FIG. 10A after the displacement step 102. As observed in said figure, the rapport 2 comprises a plurality of areas in which portions 21, 22, 23, 24 overlap. The closed contour 3 of the rapport 2 obtained in the fourth embodiment of the method is curvilinear-shaped.

The fourth embodiment of the method comprises a first emptying step 103 after the displacement step 102 and before the filling step 106, wherein areas of portions 21, 22, 23, 24 are emptied to prevent there from being areas of said portions 21, 22, 23, 24 overlapping one another. In the context of the invention, emptying is understood to mean removing the portion of image in the area to be emptied, such that said area will be blank in this case. The first emptying step 103 of the method makes it possible to generate rapports from an image, the contour of which can have any shape. Therefore, even though there are areas of portions 21, 22, 23, 24 overlapping one another, by means of the first emptying step 103 the overlaps between portions 21, 22, 23, 24 will be removed, making it possible, in the rapport 2 finally generated by the method of the invention, for each portion 21, 22, 23, 24 of the rapport 2 generated to be joined to each adjacent portion 21, 22, 23, 24 at a single point 41, 42, 43, 44, said point 41, 42, 43, 44 being located on the closed contour 3.

In one embodiment of the method, in the first emptying step 103 the areas of all the portions 21, 22, 23, 24 overlapping an area of another portion 21, 22, 23, 24 are emptied. In another embodiment of the method, the areas of portions 21, 22, 23, 24 overlapping an area of another portion 21, 22, 23, 24 will be emptied sequentially, until the existence of areas of portions 21, 22, 23, 24 overlapping one another is prevented.

The fourth embodiment of the method comprises a second emptying step 104 after the displacement step 102 and before the filling step 106, wherein the areas of portions 21, 22, 23, 24 that are located outside of the closed contour 3 are emptied. As observed in FIG. 11, the rapport 2 generated from the image 1 of FIG. 10A after the displacement step 102 comprises at least one small area of portion 23 located on the outside of the closed contour 3. Upon emptying said area located on the outside of the contour 3, the closed contour 3 is still successfully formed by at least part of the inner contours 211, 221, 231, 241 of portions 21, 22, 23, 24, thus ensuring the generated rapport 2 fitting with the adjacent rapports 2 when said rapport 2 is repeated to form a pattern. The second emptying step 104 of the method makes it possible to generate rapports 2 from an image 1 the contour of which can have any shape. Therefore, even though there are areas of portions 21, 22, 23, 24 which are arranged on the outside of the closed contour 3 once portions 21, 22, 23, 24 have been displaced in the displacement step 102, the generated rapport 2 fitting with the adjacent rapports 2 when said rapport 2 is repeated to form a pattern is ensured by means of the second emptying step 104.

The fourth embodiment of the method comprises a third emptying step 105 after the displacement step 102 and before the filling step 106, wherein at least one area of a portion 21, 22, 23, 24 located inside the closed contour 3 is emptied. FIG. 12A shows the rapport 2 after the first emptying step 104, the second emptying step 105, and the third emptying step 105. As observed in said figure, areas besides the areas already emptied in the first emptying step 103 and in the second emptying step 104 have been emptied by means of the third emptying step 105. The lines 212, 222, 232, 242 represent the limit up to which each portion 21, 22, 23, 24 contains the corresponding part of the image 1. Therefore, the part of the image 1 of each portion 21, 22, 23, 24 is delimited between the inner contour 211, 221, 231, 241 and the respective limit 212, 222, 232, 242 of each portion.

The third emptying step 105 of the method makes it possible to generate rapports 2 from an image 1 the contour of which can have any shape, since by means of said third emptying step 105 it is ensured that each portion 21, 22, 23, 24 of the generated rapport 2 is joined to each adjacent portion 21, 22, 23, 24 at a single point 41, 42, 43, 44, said point 41, 42, 43, 44 being located on the closed contour 3. In some cases, the starting image 1 has a contour such that after the implementation of the first emptying step 103 and the second emptying step 104, each portion 21, 22, 23, 24 of the generated rapport 2 is joined to each adjacent portion 21, 22, 23, 24 at a single point 41, 42, 43, 44, said point 41, 42, 43, 44 being located on the closed contour 3. However, in other cases, it is necessary to implement the third emptying step 105 to ensure that each portion 21, 22, 23, 24 of the generated rapport 2 is joined to each adjacent portion 21, 22, 23, 24 at a single point 41, 42, 43, 44, said point 41, 42, 43, 44 being located on the closed contour 3. As observed in FIGS. 12A and 12B, in the rapport 2 obtained after the displacement step 102, and the first emptying step 103, the second emptying step 104, and the third emptying step 105, each portion 21, 22, 23, 24 is joined to each adjacent portion 21, 22, 23, 24 at a single point 41, 42, 43, 44, said point 41, 42, 43, 44 being located on the closed contour 3.

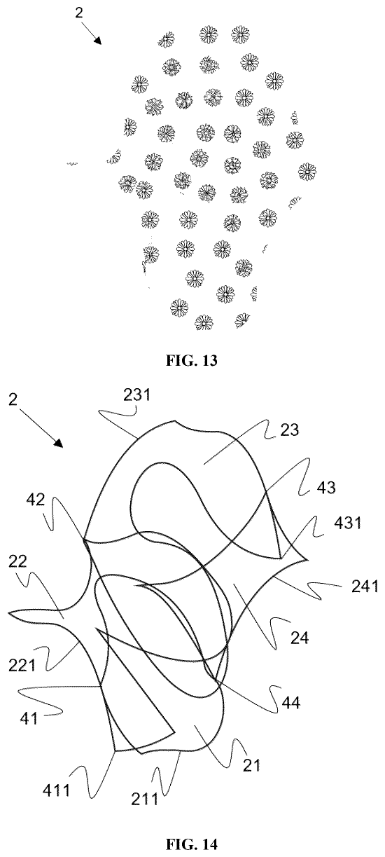

In the fourth embodiment, the method of the invention comprises a filling step 106 after the displacement step 102, and the first emptying step 103, the second emptying step 104, and the third emptying step 105 in which an area 50 arranged inside the closed contour 3 in which there is not arranged any portion 21, 22, 23, 24 is filled with an image such that there is continuity between the image of said area 50 and the parts of the image 1 of portions 21, 22, 23, 24. FIG. 13 shows the rapport 2 of FIG. 12B after the filling step 106, wherein the area 50 has been filled with an image, such that there is continuity between the image of the area 50 and the parts of the image 1 of portions 21, 22, 23, 24. By repeatedly arranging the rapport 2 of FIG. 13 vertically and horizontally, a pattern will be obtained.

In a fifth embodiment of the method of the invention, a rapport 2 is generated starting from the same image 1 used in the fourth embodiment of the method, i.e., the image 1 shown in FIGS. 10A and 10b. Like in the fourth embodiment, the image 1 of FIG. 10A is used by way of illustration of the fifth embodiment of the method of the invention. Like in the fourth embodiment, in the division step 101 of the fifth embodiment of the method of the invention, the image 1 shown in FIGS. 10A and 10b is divided into four portions 21, 22, 23, 24 by means of a first cutting line 11 and a second cutting line 12 which intersect one another in a point of the image 1 located inside the contour of the image 1. Each portion 21, 22, 23, 24 comprises a part of the image 1 and an inner contour 211, 221, 231, 241 generated by the cutting lines 11, 12.

In the displacement step 102 of the fifth embodiment of the invention, each portion 21, 22, 23, 24 is displaced linearly to a diametrically opposite position giving rise to the rapport 2, such that the rapport 2 comprises a closed contour 3 formed by the inner contours 211, 241 of portions 21, 24, and by part of the inner contours 221, 231 of portions 22, 23, as shown in FIG. 14. When comparing the rapport 2 of FIG. 14 obtained in the fifth embodiment of the method with the rapport 2 of FIG. 11 obtained in the fourth embodiment of the method, it can be observed that in FIG. 11 the inner contour 211 of portion 21 and the inner contour 221 of portion 22 coincide at the point identified as 411 in FIG. 13. Point 411 belongs to the closed contour 3. However, in FIG. 14 it can be observed that in the rapport 2 obtained in the fifth embodiment the inner contour 211 of portion 21 and the inner contour 221 of portion 22 coincide at point 41 of FIG. 13, also located on the closed contour 3 of the rapport 2. In the same way, in the rapport 2 obtained in the fourth embodiment of the method, the inner contour 231 of portion 23 and the inner contour 241 of portion 24 coincide at the point identified as point 431 in FIG. 14, whereas in the fifth embodiment the inner contour 231 of portion 23 and the inner contour 241 of portion 24 coincide at the point identified as point 43 in FIG. 14, both point 43 and point 431 being located on the closed contour 3 of the rapport 2. In FIG. 14 it can be observed that the shape of the portion of the inner contour 221 between point 41 and point 411 corresponds with the shape of the portion of the inner contour 231 between point 43 and point 431. For this reason, despite the fact that the closed contour 3 is not formed by the entirety of the inner contour 221 and of the contour 231, it is ensured that the resulting rapport 2, as it is repeated vertically and horizontally to form a pattern 2, fits with the adjacent rapports 2. The closed contour 3 of the rapport 2 obtained in the fifth embodiment of the method is curvilinear-shaped.

The fifth embodiment of the method comprises a first emptying step 103 after the displacement step 102 and before the filling step 106, wherein areas of portions 21, 22, 23, 24 are emptied to prevent there from being areas of said portions 21, 22, 23, 24 overlapping one another.

The fifth embodiment of the method comprises a second emptying step 104 after the displacement step 102 and before the filling step 106, wherein the areas of portions 21, 22, 23, 24 that are located outside of the closed contour 3 are emptied. As observed in FIG. 14, the rapport 2 comprises at least one small area of portion 22 located on the outside of the closed contour 3. Upon emptying said area, the closed contour 3 is still successfully formed by at least part of the inner contours 211, 221, 231, 241 of portions 21, 22, 23, 24, thus ensuring the generated rapport 2 fitting with the adjacent rapports 2 when said rapport 2 is repeated to form a pattern.

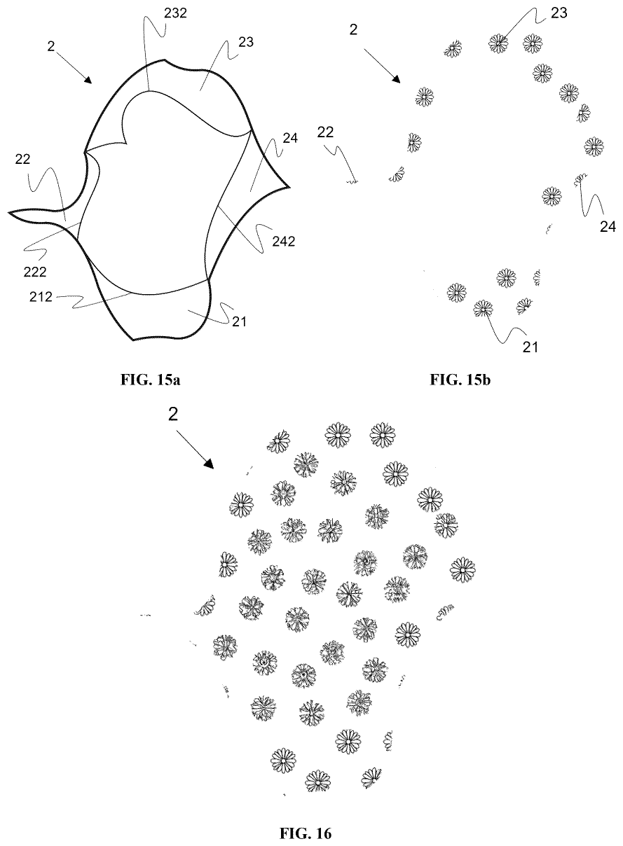

The fifth embodiment of the method comprises a third emptying step 105 after the displacement step 102 and before the filling step 106, wherein is emptied at least one area of a portion 21, 22, 23, 24 located inside the closed contour 3. FIG. 15A shows the rapport 2 after the first emptying step 103, the second emptying step 104, and the third emptying step 105. As observed in said figure, areas besides the areas already emptied in the first emptying step 103 and the second emptying step 104 have been emptied by means of the third emptying step 105, which makes it possible for each portion 21, 22, 23, 24 of the generated rapport 2 to be joined to each adjacent portion 21, 22, 23, 24 at a single point 41, 42, 43, 44, said point 41, 42, 43, 44 being located on the closed contour 3.

In the fifth embodiment, the method of the invention comprises a filling step 106 after the displacement step 102, and the first emptying step 103, the second emptying step 104, and the third emptying step 105 in which an area 50 arranged inside the closed contour 3 in which there is not arranged any portion 21, 22, 23, 24 is filled with an image such that there is continuity between the image of said area 50 and the parts of the image 1 of portions 21, 22, 23, 24. FIG. 16 shows the rapport 2 of FIG. 15B after the filling step 106, wherein the area 50 has been filled with an image, such that there is continuity between the image of the area 50 and the parts of the remaining image 1 of portions 21, 22, 23, 24. As the rapport 2 of FIG. 16 is repeatedly arranged vertically and horizontally, a pattern will be obtained.

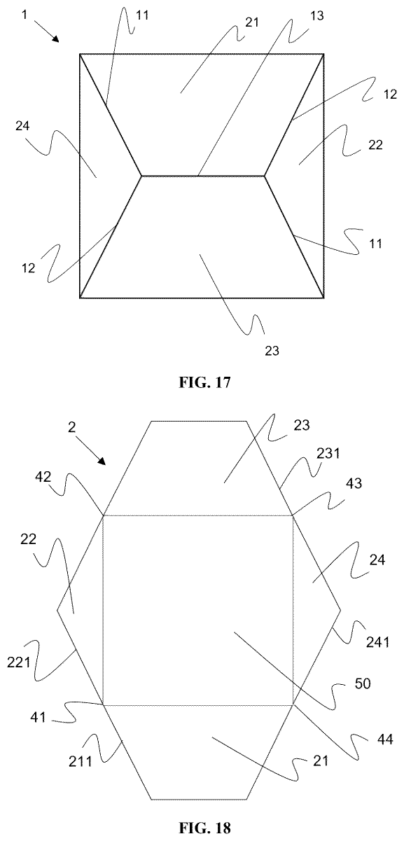

FIG. 17 shows a blank image 1 used in a sixth embodiment of the method of the invention. In the sixth embodiment of the method of the invention, the image 1 of FIG. 17 is used by way of illustration.

In the division step 101 of the sixth embodiment of the method of the invention, the image 1 shown in FIG. 17 is divided into four portions 21, 22, 23, 24 by means of a first cutting line 11 and a second cutting line 12 which intersect one another. Said first cutting line 11 and second cutting line 12 intersect one another at least at one point of the image 1 located inside the contour of the image 1. Each portion 21, 22, 23, 24 comprises a part of the image 1 and an inner contour 211, 221, 231, 241 generated by the cutting lines 11, 12.

In the displacement step 102 of the sixth embodiment of the invention, each portion 21, 22, 23, 24 is displaced linearly to a diametrically opposite position giving rise to a rapport 2, such that the rapport 2 comprises a closed contour 3 formed by the inner contours 211, 221, 231, 241 of portions 21, 22, 23, 24, as shown in FIG. 18.

In the rapport 2 obtained once portions 21, 22, 23, 24 have been displaced in the displacement step 102 of the sixth embodiment of the method of the invention, each portion 21, 22, 23, 24 is joined to each adjacent portion 21, 22, 23, 24 at a single point 41, 42, 43, 44, said point 41, 42, 43, 44 being located on the closed contour 3, as shown in FIG. 18.

In the sixth embodiment, the method of the invention comprises a filling step 106 after the displacement step 102 in which an area 50 arranged inside the closed contour 3 in which there is not arranged any portion 21, 22, 23, 24 is filled with an image such that there is continuity between the image of said area 50 and the parts of the image 1 of portions 21, 22, 23, 24.

In the sixth embodiment, the first cutting line 11 and the second cutting line 12 have a common segment 13. In said embodiment, the first cutting line 11 and the second cutting line 12, in addition to intersecting one another, have a common segment 13.

FIG. 20 shows the flowchart of the fourth and fifth embodiments of the method of the invention. In other embodiments described herein, only some of these steps are reproduced.

In one embodiment of the method of the invention, the starting image 1 has a contour with an arbitrary shape, i.e., it can be formed by a plurality of straight and/or curved lines, or even have a freely drawn shape.

In one embodiment of the method of the invention, cutting line 11 and cutting line 12 have an arbitrary shape, i.e., they can be formed by a plurality of straight and/or curved lines, or even have a freely drawn shape.

In an embodiment of the method of the invention, the method is configured to generate at least two different two-dimensional rapports 2 starting from a single image 1.

1. A computer-implemented method for generating a two-dimensional rapport starting from an image, the computer-implemented method comprising;
a division step in which the image is divided into at least three portions by at least a first cutting line and a second cutting line that intersect one another, each of the at least three portions comprising a part of the image and an inner contour generated by the first and second cutting lines;
a displacement step after the division step in which each of the at least three portions is displaced linearly to a diametrically opposite position, such that the rapport comprises a closed contour formed by an interconnection of the inner contours of the at least three portions, the inner contour of each of the at least three portions being joined to an adjacent of the at least three portions at a single point; and
a filling step after the displacement step in which an area arranged inside the closed contour in which there is not arranged any of the at least three portions is filled with an image such that there is continuity between the image of the area and the parts of the image of the at least three portions.

2. The computer-implemented method according to claim 1, wherein the single points joining the inner contour of each of the at least three portions to an adjacent of the at least three portion are located on the closed contour.

3. The computer-implemented method according to claim 1, wherein the first cutting line and the second cutting line intersect one another at a single point.

4. The computer-implemented method according to claim 2, wherein the first cutting line and the second cutting line intersect one another at a single point.

5. The computer-implemented method according to claim 1, wherein the first cutting line and the second cutting line have a common segment.

6. The computer-implemented method according to claim 2, wherein the first cutting line and the second cutting line have a common segment.

7. The computer-implemented method according to claim 1, wherein the image that is divided has a square-shaped contour, and the closed contour of the rapport is square-shaped.

8. The computer-implemented method according to claim 1, wherein the image that is divided has a rectangular-shaped contour, and the closed contour of the rapport is parallelogram-shaped.

9. The computer-implemented method according to claim 1, wherein the image that s divided has a curvilinear-shaped contour, and the closed contour of the rapport is curvilinear-shaped.

10. The computer-implemented method according to claim 1, wherein each of the first cutting line and the second cutting line is a straight line.

11. The computer-implemented method according to claim 1, wherein each of the first cutting line and the second cutting line is a curved line.

12. The computer-implemented method according to claim 1, further comprising a first emptying step that occurs upon an area of two or more of the at least three portions overlapping with one another after the displacement step, the first emptying step being before the filling step and comprising emptying an area of one of the at least three portions to prevent the overlapping.

13. The computer-implemented method according to claim 2, further comprising a first emptying step that occurs upon an area of two or more of the at least three portions overlapping with one another after the displacement step, the first emptying step being before the filling step and comprising emptying an area of one of the at least three portions to prevent the overlapping.

14. The computer-implemented method according to claim 3, further comprising a first emptying step that occurs upon an area of two or more of the at least three portions overlapping with one another after the displacement step, the first emptying step being before the filling step and comprising emptying an area of one of the at least three portions to prevent the overlapping.

15. The computer-implemented method according to claim 4, further comprising a first emptying step that occurs upon an area of two or more of the at least three portions overlapping with one another after the displacement step, the first emptying step being before the filling step and comprising emptying an area of one of the at least three portions to prevent the overlapping.

16. The computer-implemented method according to claim 5, further comprising a first emptying step that occurs upon an area of two or more of the at least three portions overlapping with one another after the displacement step, the first emptying step being before the filling step and comprising emptying an area of one of the at least three portions to prevent the overlapping.

17. The computer-implemented method according to claim 1, comprising a second emptying step that occurs upon an area of one or more of the at least three portions being located outside the closed contour after the displacement step, the second emptying step being before the filling step and comprising emptying any area of the at least three portions located outside of the closed contour.

18. The computer-implemented method according to claim 12, comprising a second emptying step that occurs upon an area of one or more of the at least three portions being located outside the closed contour after the displacement step, the second emptying step being before the filling step and comprising emptying any area of the at least three portions located outside of the closed contour.

19. A computer system comprising;
a processor;
a memory element;
a bus;
a network processing unit interconnected with at least one network input/output interface;
an input/output interface; and
a computer program stored in the memory element, the computer program comprising a plurality of instructions which, when executed by the processor cause the processor to execute the division step, the displacement step, and the filling step of claim 1.

20. A memory element that stores a computer program, the computer program comprising a plurality of instructions which, when executed by a processor of a computer, cause the processor to execute the division step, the displacement step, and the filling step of claim 1.
